(19) United States
(12) Patent Application Publication
(10) Pub. No.: US 2012/0152042 A1
(43) Pub. Date: Jun. 21, 2012

(54) Multi-Dimensional Micro Driver

(75) Inventors: Ta-Ching Li, Taoyuan County (TW); Cheng-Der Chiang, Taipei (TW); Pin-Chun Tsai, Taoyuan County (TW); Yu-Shun Cheng, Taichung County (TW); Sheng-Chih Shen, Taoyuan County (TW)

(73) Assignee: Chung-Shan Institute of Science and Technology, Armaments, Bureau, Ministry of National Defense, Taoyuan County (TW)

(21) Appl. No.: 12/973,950

(22) Filed: Dec. 21, 2010

(51) Int. Cl. F16H 21/16

(52) U.S. Cl. 74/25

(57) ABSTRACT

A micro driver includes a translational unit, an actuating unit and a rotational unit. The translational unit includes translational elements movable relative to one another. The actuating unit includes two opposite actuators connected to each of the translational elements. The actuators are operable to move the translational elements relative to one another. The rotational unit includes a frame and semi-spheres each located in an aperture defined in the frame and in contact with the uppermost one of the translational elements so that the uppermost translational element rotates the semi-spheres on the frame when the actuators causes the translational elements to move relative to one another.

### BACKGROUND OF INVENTION

1. Field of Invention

The present invention relates to a multi-dimensional micro driver and, more particularly, to a multi-dimensional micro driver including piezoelectric element for moving a translational unit to rotate a rotational unit.

2. Related Prior Art

Energy and environmental protection are two important issues to be tackled in the 21^{st} century. To make economic progresses, energy is consumed in all kinds of activities. As the technology advances, our need for energy increases. Fossil fuel is however running out and will not be a reliable source of energy in the near future. On the other hand, the consumption of the fossil fuel produces a lot of carbon dioxide that worsens the green-house effect. Hence, the global warming accelerates and the weather change becomes radical.

In recent years, in consideration of the fossil fuel that is running out and the green-house effect that is getting worse, renewable energy is developed to replace the fossil fuel. The renewable energy such as solar energy, wind energy, hydraulic energy is clean and environmentally friendly. The solar energy is believed to be the most abundant and lasting energy. The solar energy is stable, safe, convenient and almost pollution-free. Taiwan is located in the subtropics, and enjoys long hours of abundant sunshine. The solar energy is therefore promising in Taiwan. To convert the solar energy to electricity, a solar cell is necessary. To take the most advantage of the solar energy, a sun-tracking device is used to align the solar cell to the sun.

Conventional sun-tracking devices can be classified into single-axial sun-tracking devices and dual-axial sun-tracking devices. The dual-axial sun-tracking devices track the sun better than the single-axial sun-tracking devices do because the sun does not only move from the east to the west but also from the north to the south relative to the earth in different seasons.

Alternatively, the operation of the conventional sun-tracking devices can be classified into active sun-tracking and passive sun-tracking. In the active sun-tracking, a controller calculates the track of the sun and sends a signal related to the calculated track to a driver to align a solar cell array to the sun. The active sun-tracking is hence called the “open-loop control.” In the passive sun-tracking, a sensor array detects the position of the sun and provides a signal related to the detected position to a driver to align a solar cell array to the sun. The passive sun-tracking is hence called the “closed-loop control.” The dual-axial sun-tracking devices are often operated based on the passive sun-tracking. That is, a dual-axial sun-tracking device often includes a sensor array to detect the position of the sun and provides a signal related to the detected position to a driver to align a solar cell array to the sun, thus absorbing the optimal amount of the solar energy. Therefore, the cooperation of the sensor array with the driver is very important for a dual-axial sun-tracking device.

A sun-tracking device for use in a photovoltaic system is generally bulky and carries hundreds of kilograms. However, there is a developing trend for light, personal and movable photovoltaic systems. A light, personal and movable photovoltaic system however cannot use a sun-tracking device. It has become an important issue to develop micro drivers for the light, personal and movable photovoltaic systems.

The present invention is therefore intended to obviate or at least alleviate the problems encountered in prior art.

### SUMMARY OF INVENTION

It is the primary objective of the present invention to provide a light, personal and movable photovoltaic system with a micro driver.

To achieve the foregoing objective, the micro driver includes a translational unit, an actuating unit and a rotational unit. The translational unit includes translational elements movable relative to one another. The actuating unit includes two opposite actuators connected to each of the translational elements. The actuators are operable to move the translational elements relative to one another. The rotational unit includes a frame and semi-spheres each located in an aperture defined in the frame and in contact with the uppermost one of the translational elements so that the uppermost translational element rotates the semi-spheres on the frame when the actuators causes the translational elements to move relative to one another.

In an aspect, the translational elements are square or rectangular plates.

In another aspect, the uppermost translational element synchronously rotates the semi-spheres on the frame by friction.

In another aspect, the frame prevents translation of the semi-spheres thereon.

In another aspect, the actuating unit includes piezoelectric elements, linear actuators or motors.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a multi-dimensional micro driver according to the preferred embodiment of the present invention;

FIGS. 2 to 4 are perspective views of a translational unit of the multi-dimensional micro driver shown in FIG. 1 in various positions; and

FIGS. 5 to 9 are perspective views of a rotational unit and the translational unit of the multi-dimensional micro driver shown in FIG. 1 in various positions.

### DETAILED DESCRIPTION OF PREFERRED EMBODIMENT

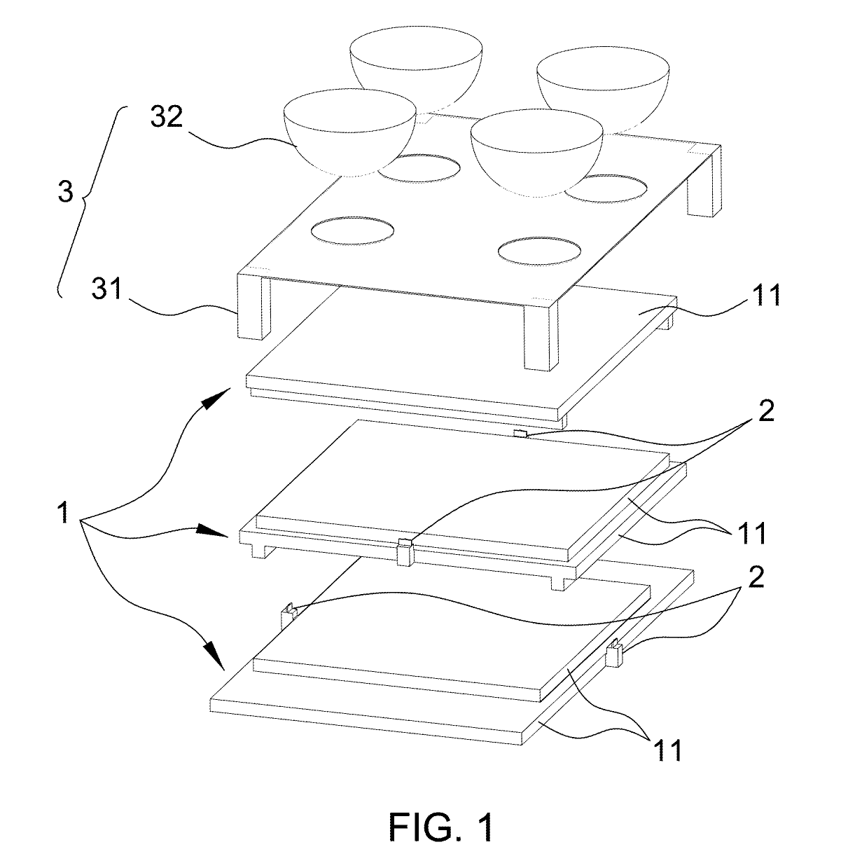

Referring to FIG. 1, a multi-dimensional micro driver includes a translational unit 1, an actuating unit and a rotational unit 3 according to the preferred embodiment of the present invention. The multi-dimensional micro driver can be used in a light, personal and movable photovoltaic system.

The translational unit 1 includes translational elements 11 overlapping one another. Each of the translational elements 11 is a square plate or a rectangular plate. There can be relative translation between any two adjacent ones of the translational elements 11. To facilitate the relative translation, there can be rails provided between any two adjacent ones of the translational elements 11.

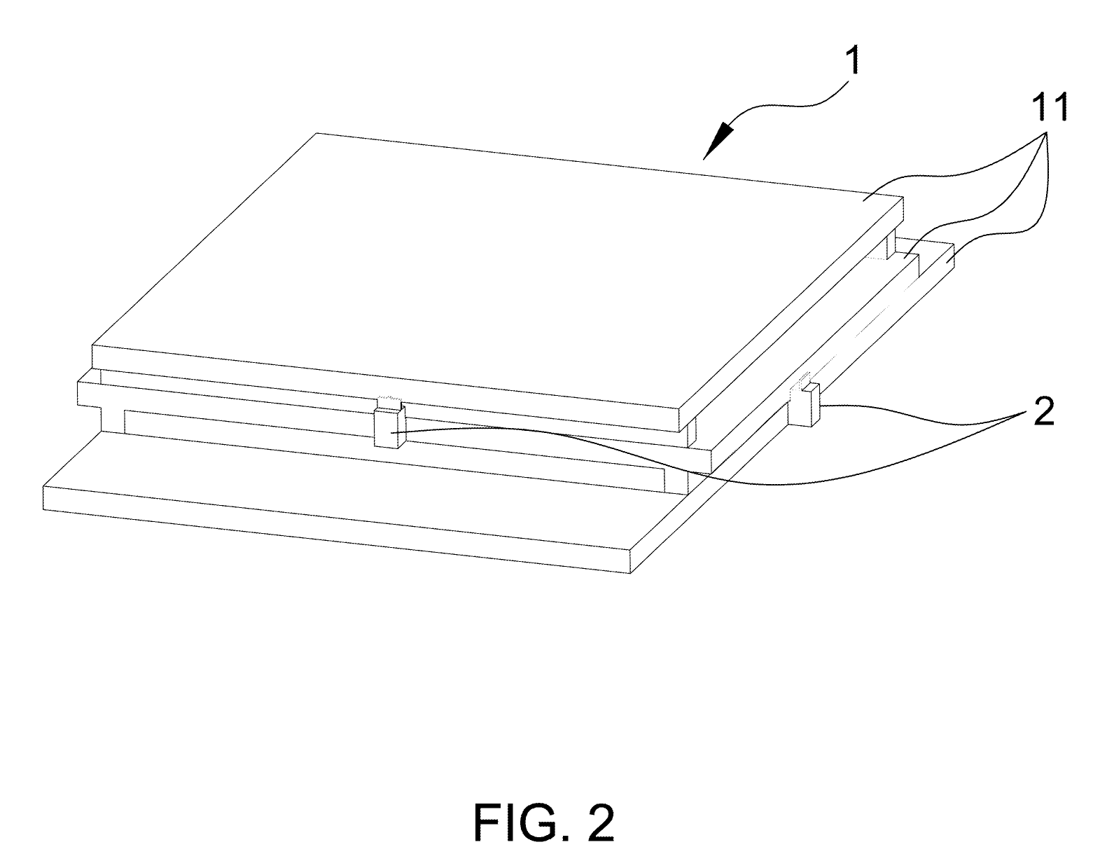

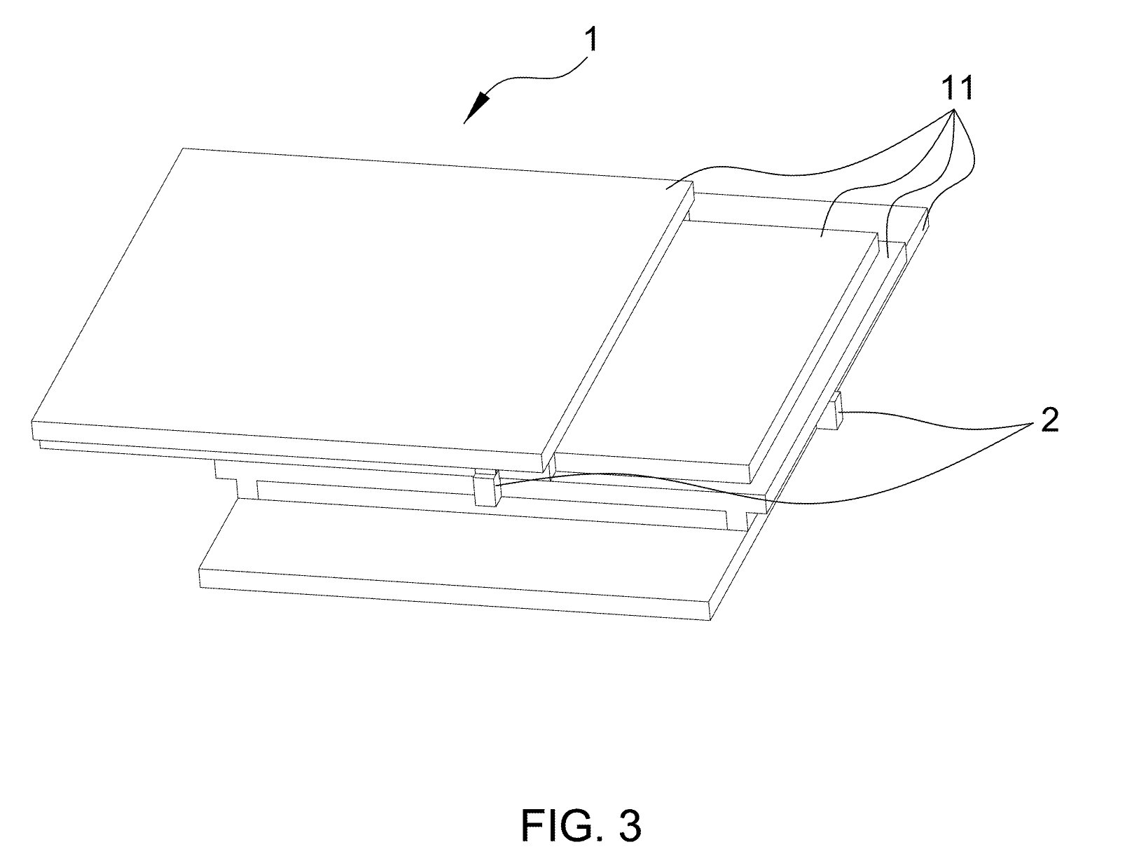

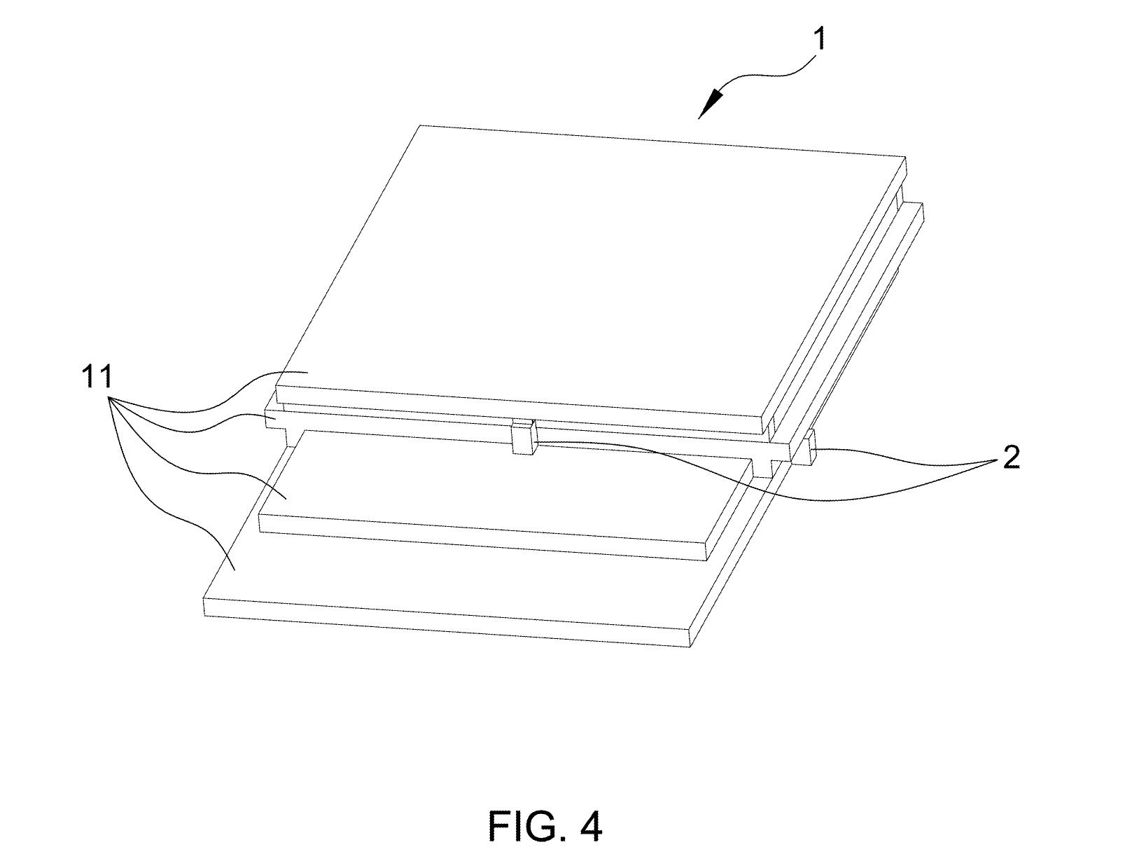

The actuating unit includes two opposite actuators 2 connected to each of the translational elements 11. Each of the actuators 2 includes two pairs of symmetric piezoelectric elements connected to the related translational element 11. Based on the reverse piezoelectric effect, the symmetric piezoelectric elements provide vibration at an ultrasonic frequency. By switching the driving voltage on the surfaces of the electrodes of the piezoelectric elements, the symmetric piezoelectric elements provide single-phased and different types of vibration to provide the relative translation between the translational elements 11 as shown in FIGS. 2 through 4.

Each of the actuators of the actuating unit 2 may include a linear actuator instead of the two pairs of symmetric piezoelectric elements. Moreover, each of the actuators of the actuating unit 2 may include a motor instead of the two pairs of symmetric piezoelectric elements.

The rotational unit 3 is located on the translational unit 1. The rotational unit 3 includes a frame 31 and semi-spheres 32. The frame 31 is separated from the uppermost one of the translational elements 11. The frame 31 includes apertures each for receiving a related one of the semi-spheres 32. All of the semi-spheres 32 are in contact with the uppermost translational element 11. By switching the driving voltage on the surfaces of the electrodes of the piezoelectric elements, the symmetric piezoelectric elements provide single-phased and different types of vibration to move the uppermost translational element 11 relative to the semi-spheres 32, thus rotating the semi-spheres 32.

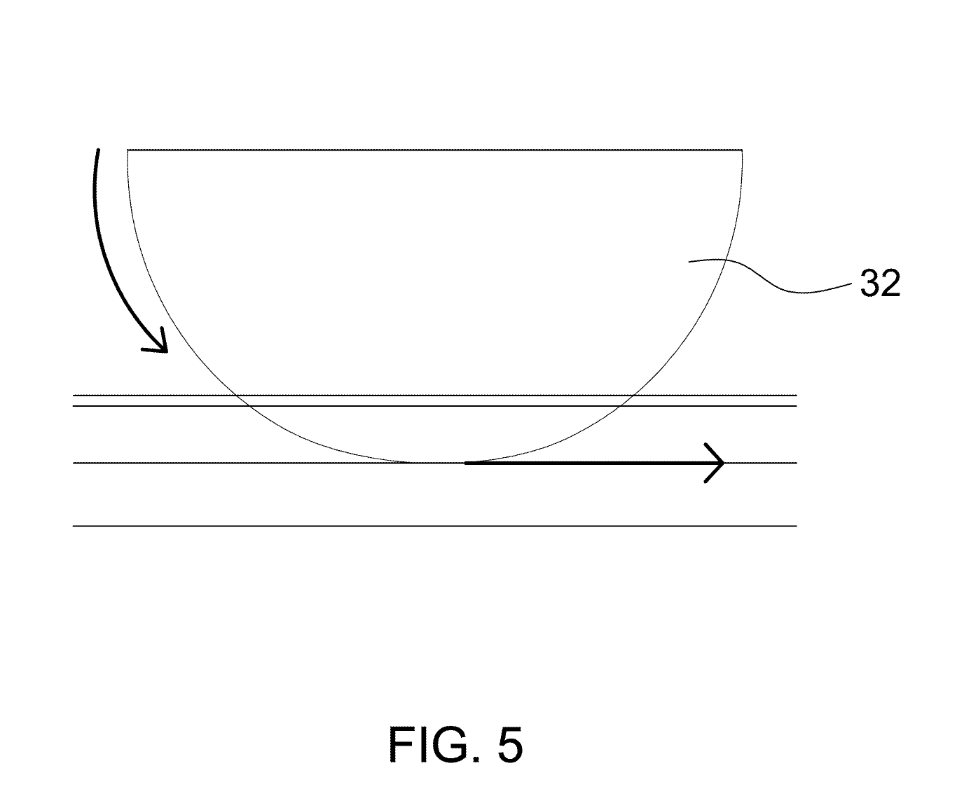

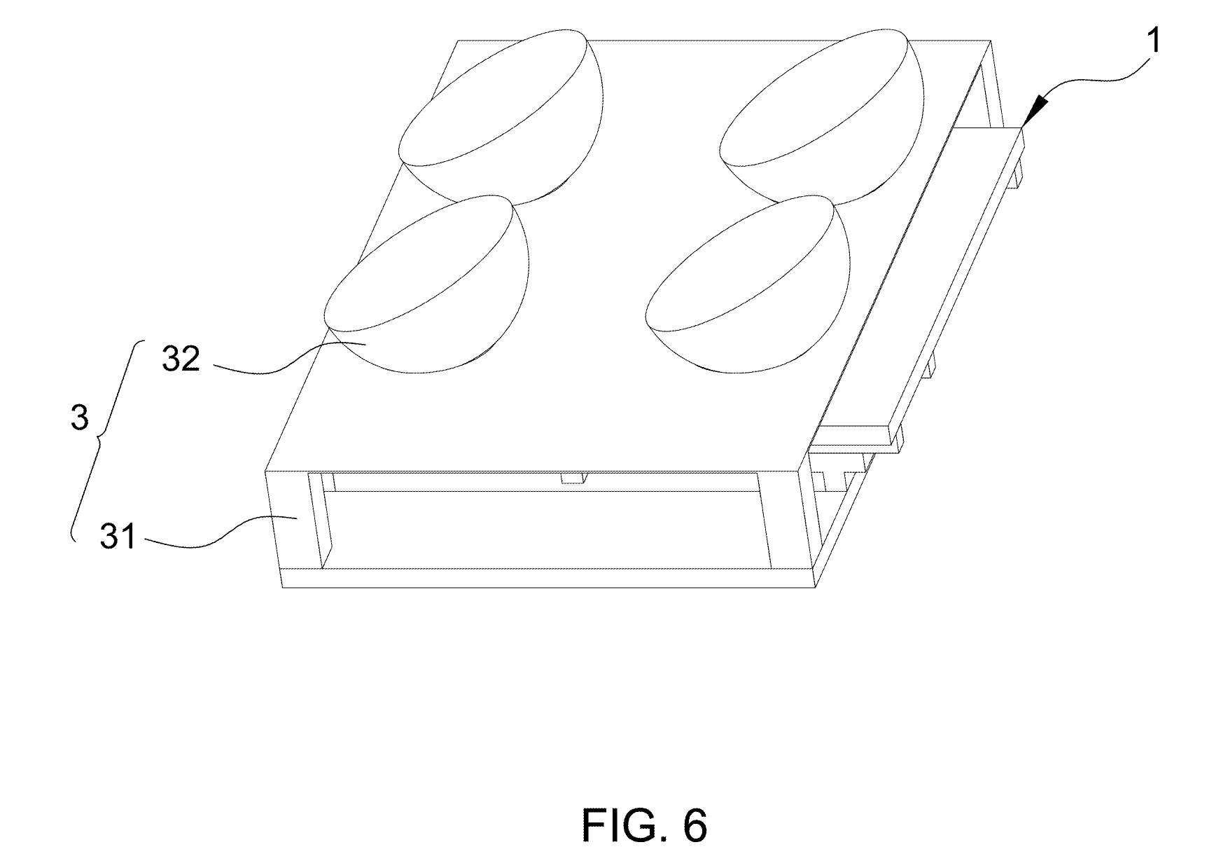

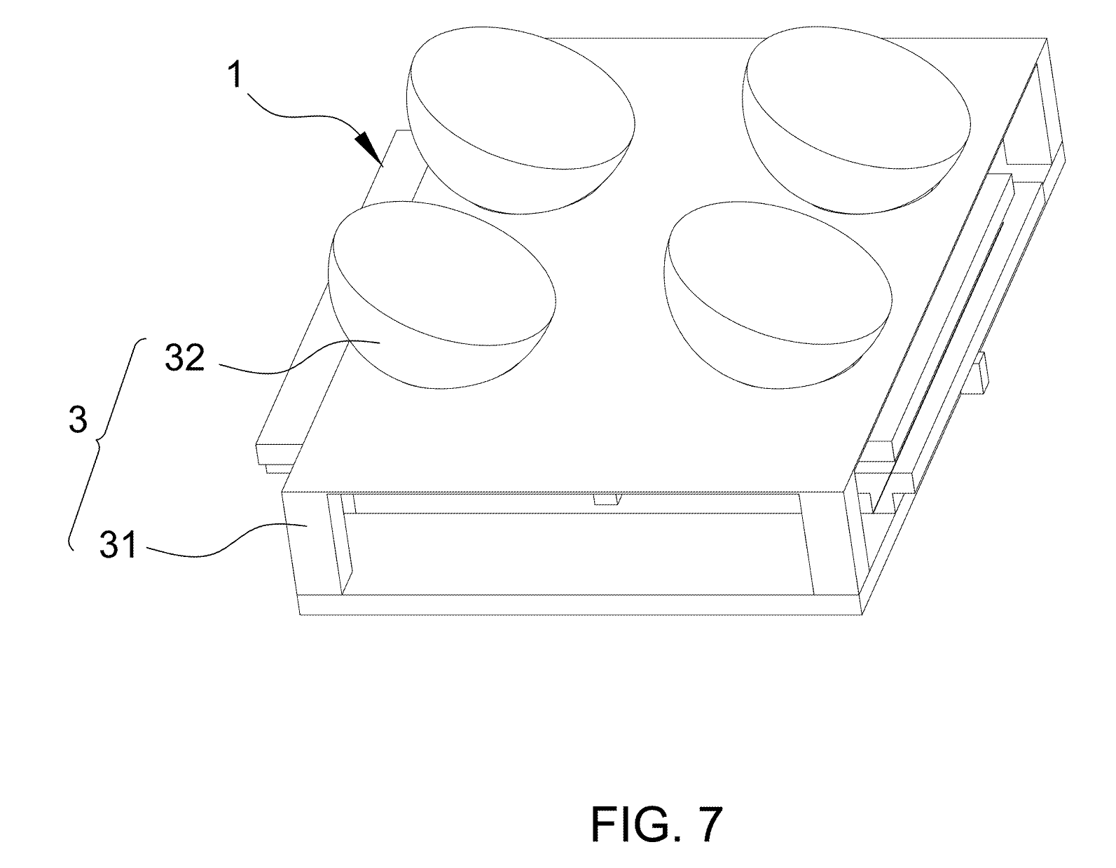

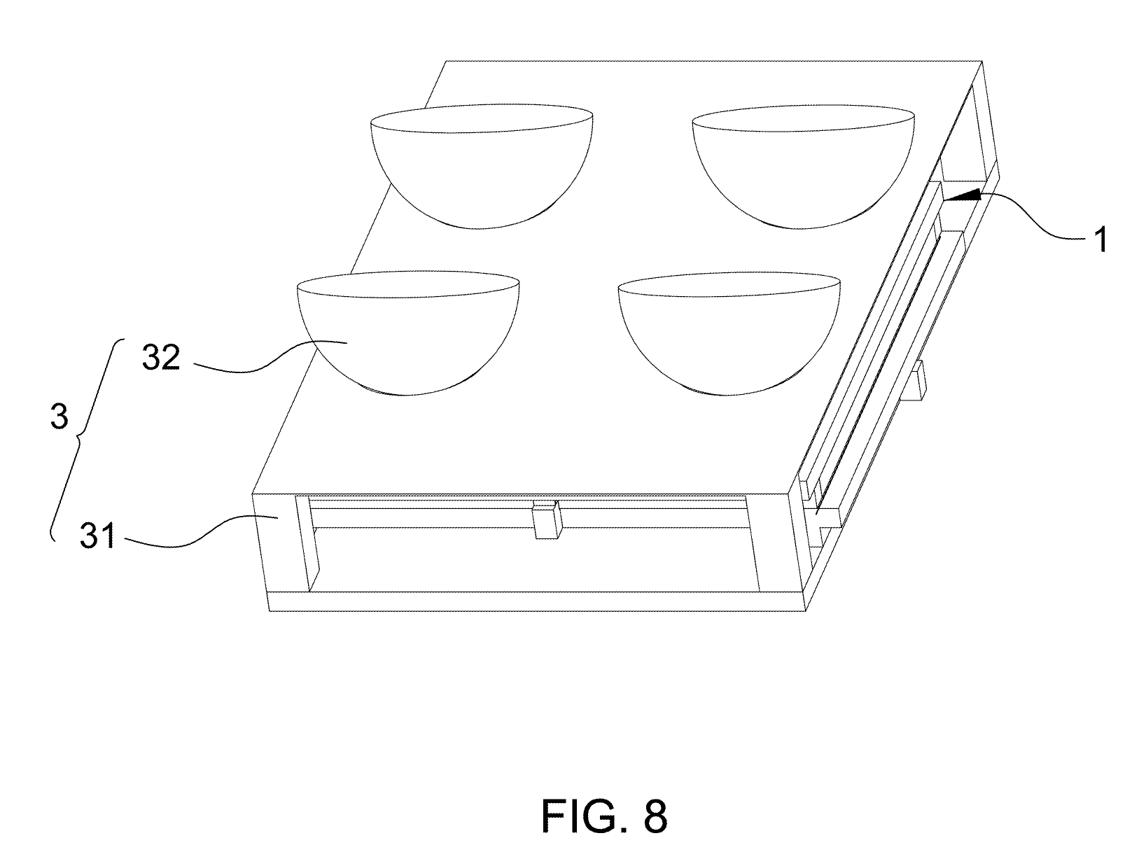

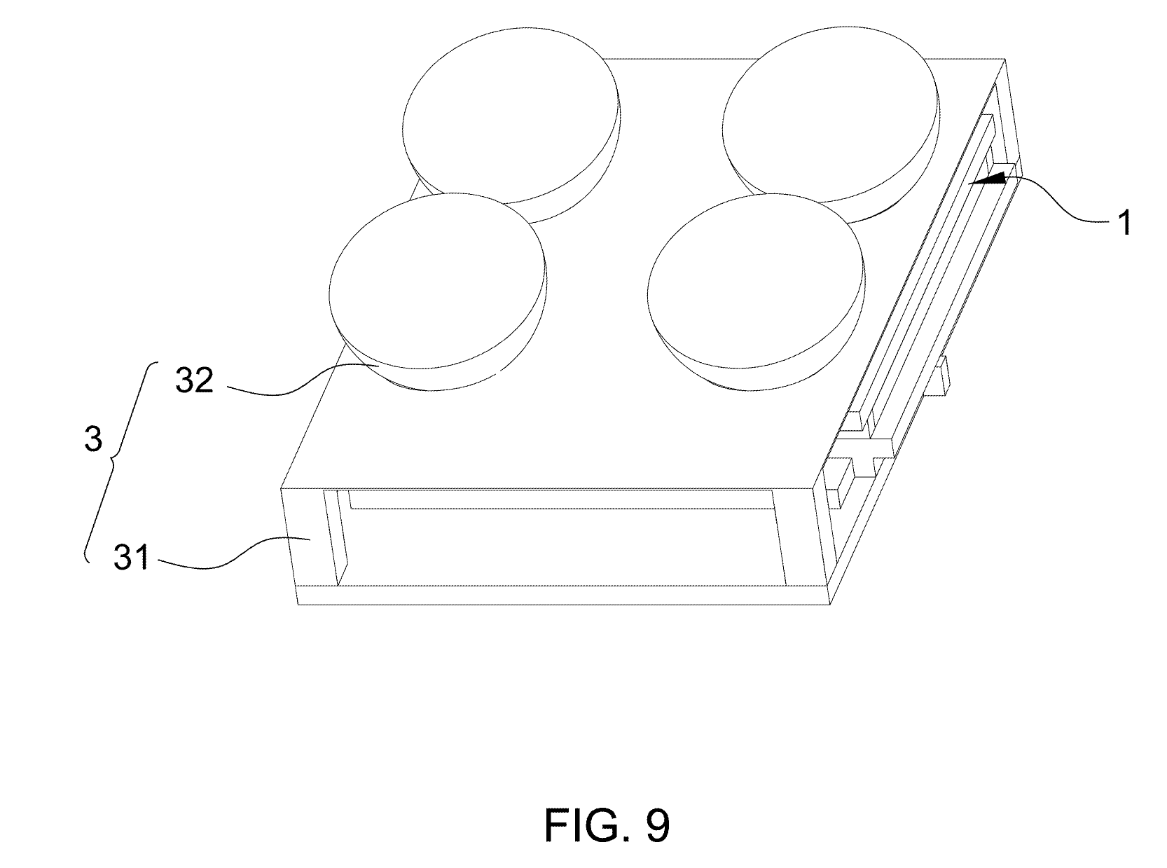

Referring to FIGS. 5 to 9, as the translational elements 11 move relative to one another, the uppermost translational element 11 moves relative to the semi-spheres 32 and rotates the semi-spheres 32 by friction. In detail, there is considerable friction between the uppermost translational element 11 and the semi-spheres 32 but little friction between the frame 31 and the semi-spheres 32. The considerable friction between the uppermost translational element 11 and the semi-spheres 32 avoids sliding of the uppermost translational element 11 relative to the semi-spheres 32. The little friction between the frame 31 and the semi-spheres 32 allows sliding of the frame 31 relative to the semi-spheres 32. The frame 31 prevents the centers of the semi-spheres 32 from translation. Thus, the considerable friction between the uppermost translational element 11 and the semi-spheres 32 provide torques for rotating the semi-spheres 32 on the frame 31.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A multi-dimensional micro driver including:
a translational unit 1 including translational elements 11 movable relative to one another;
an actuating unit including two opposite actuators 2 connected to each of the translational elements 11, wherein the actuators 2 are operable to move the translational elements 11 relative to one another; and
a rotational unit 3 including a frame 31 and semi-spheres 32 each located in an aperture defined in the frame 31 and in contact with the uppermost one of the translational elements 11 so that the uppermost translational element 11 rotates the semi-spheres 32 on the frame 31 when the actuators 2 causes the translational elements 11 to move relative to one another.

2. The multi-dimensional micro driver according to claim 1, wherein the translational elements 11 are square plates.

3. The multi-dimensional micro driver according to claim 1, wherein the translational elements 11 are rectangular plates.

4. The multi-dimensional micro driver according to claim 1, wherein the uppermost translational element 11 rotates the semi-spheres 32 on the frame 31 by friction.

5. The multi-dimensional micro driver according to claim 1, wherein the frame 31 prevents translation of the semi-spheres 32 thereon.

6. The multi-dimensional micro driver according to claim 1, wherein the uppermost translational element 11 rotates the semi-spheres 32 on the frame 31 synchronously.

7. The multi-dimensional micro driver according to claim 1, wherein the actuating unit 2 includes piezoelectric elements.

8. The multi-dimensional micro driver according to claim 1, wherein the actuating unit 2 includes linear actuators.

9. The multi-dimensional micro driver according to claim 1, wherein the actuating unit 2 includes motors.
